(19) United States
(12) Patent Application Publication
(10) Pub. No.: US 2022/0128860 A1
(43) Pub. Date: Apr. 28, 2022

(54) REFLECTIVE DISPLAY SUBSTRATE AND METHOD FOR FABRICATING THE SAME, DISPLAY PANEL AND DISPLAY DEVICE

(71) Applicant: BOE Technology Group Co., Ltd., Beijing (CN)

(72) Inventor: Yingtao WANG, Beijing (CN)

(21) Appl. No.: 17/503,022

(22) Filed: Oct. 15, 2021

(30) Foreign Application Priority Data
Oct. 26, 2020 (CN) 202011156446.5

(51) Int. Cl. G02F 1/1335; G02F 1/1333; G02F 1/137; G02F 1/13363

(52) U.S. Cl. CPC G02F 1/133555; G02F 1/133638; G02F 1/13725; G02F 1/133345

(57) ABSTRACT

Disclosed are a reflective display substrate and a method for fabricating the same, a display panel, and a display device. The reflective display substrate includes a base substrate and a resonant cavity layer. The base substrate has a plurality of pixel regions. The resonant cavity layer is disposed on a first side of the base substrate. The resonant cavity layer includes a plurality of resonant cavities. The plurality of resonant cavities are in one-to-one correspondence with the plurality of pixel regions. The resonant cavity is disposed in the corresponding pixel region. The resonant cavity is configured to enhance reflection of light of a first color in incident light and reduce reflection of light of a second color in the incident light.

### CROSS-REFERENCE TO RELATED APPLICATION

This application claims priority to Chinese Patent Application No. 202011156446.5, filed on Oct. 26, 2020 and entitled “REFLECTIVE DISPLAY SUBSTRATE AND METHOD FOR FABRICATING THE SAME, DISPLAY PANEL AND DISPLAY DEVICE”, which is incorporated herein by reference in its entirety.

### TECHNICAL FIELD

The present disclosure relates to the field of display technologies, and in particular relates to a reflective display substrate and a method for fabricating the same, a display panel, and a display device.

### BACKGROUND

In accordance with different types of light sources used by display devices, liquid crystal display devices are divided into three types: transmissive, reflective, and transflective display devices. Reflective display devices realize display by reflecting ambient light incident into the reflective display devices.

In the related art, a reflective display device includes a color filter substrate and an array substrate that are arranged oppositely, and a liquid crystal layer disposed between the color filter substrate and the array substrate. Ambient light is emitted to the array substrate through the color filter substrate, and is reflected by a reflective layer on the array substrate such that the light is emitted from the color filter substrate again, such that the display device displays a picture.

In the related art, the reflective layer has a low reflectivity to light, which reduces luminance of the display device.

### SUMMARY

Embodiments of the present disclosure provide a reflective display substrate and a method for fabricating the same, a display panel and a display device, which can improve the luminance of the display device.

In one aspect, the embodiments of the present disclosure provide a reflective display substrate. The reflective display substrate includes:

a base substrate having a plurality of pixel regions; and

a resonant cavity layer, disposed on a first side of the base substrate, wherein the resonant cavity layer includes a plurality of resonant cavities, wherein the plurality of resonant cavities are in one-to-one correspondence with the plurality of pixel regions, and the resonant cavity is disposed in the corresponding pixel region, the resonant cavity is configured to enhance reflection of light of a first color in incident light and reduce reflection of light of a second color in the incident light, wherein the first color is a color corresponding to the pixel region where the resonant cavity is disposed, the second color is a color other than the first color in a color component of the incident light, and the incident light is light incident from one side of the resonant cavity layer.

In some embodiments, the resonant cavity layer includes a first reflective layer, a transparent insulative layer, and a transflective layer, wherein the first reflective layer, the transparent insulative layer, and the transflective layer are sequentially stacked on the first side;

the first reflective layer, the transparent insulative layer, and the transflective layer disposed in a first pixel region define a first resonant cavity, wherein the first resonant cavity is a resonant cavity corresponding to the first pixel region, and the first pixel region is any one of the plurality of pixel regions; and

in a direction perpendicular to the first side, thicknesses of the transparent insulative layers in the pixel regions with different colors are different.

In some embodiments, the plurality of pixel regions include a blue pixel region, a green pixel region, and a red pixel region;

the transparent insulative layer includes a first transparent insulative block, a second transparent insulative block, and a third transparent insulative block, wherein a material of the first transparent insulative block, a material of the second transparent insulative block, and a material of the third transparent insulative block are the same;

the first transparent insulative block is disposed in the blue pixel region, the second transparent insulative block is disposed in the green pixel region, and the third transparent insulative block is disposed in the red pixel region; and

in the direction perpendicular to the first side, a thickness of the first transparent insulative block is greater than a thickness of the second transparent insulative block, and a thickness of the second transparent insulative block is greater than a thickness of the third transparent insulative block.

In some embodiments, the thickness of the first transparent insulative block is between 330 nanometers and 350 nanometers;

the thickness of the second transparent insulative block is between 295 nanometers and 315 nanometers; and

the thickness of the third transparent insulative block is between 190 nanometers and 210 nanometers.

In some embodiments, the transparent insulative layer includes any one of: a silicon dioxide layer, a silicon nitride layer, and a silicon oxynitride layer.

In some embodiments, the first reflective layer includes any one of: a silver layer, an aluminum layer, an indium tin oxide-silver-indium tin oxide stacked layer and a silver-titanium stacked layer.

In some embodiments, the transflective layer includes any one of: a tungsten layer and a titanium layer.

In some embodiments, the reflective display substrate further includes a first planarization layer, wherein the first planarization layer is disposed on a side, distal from the base substrate, of the resonant cavity layer.

In another aspect, the embodiments of the present disclosure provide a method for fabricating a reflective display substrate. The method includes:

providing a base substrate having a plurality of pixel regions; and

fabricating a resonant cavity layer on a first side of the base substrate, wherein the resonant cavity layer includes a plurality of resonant cavities, wherein the plurality of resonant cavities are in one-to-one correspondence with the plurality of pixel regions, the resonant cavity is disposed in the corresponding pixel region, and the resonant cavity is configured to enhance reflection of light of a first color in incident light and reduce reflection of light of a second color in the incident light, wherein the first color is a color corresponding to the pixel region where the resonant cavity is disposed, the second color is a color other than the first color in a color component of the incident light, and the incident light is light incident from one side of the resonant cavity layer.

In some embodiments, fabricating the resonant cavity layer on the base substrate includes:

fabricating a first reflective layer on the first side of the base substrate;

fabricating a transparent insulative layer on a side, distal from the base substrate, of the first reflective layer, wherein in a direction perpendicular to the first side, thicknesses of the transparent insulative layers in the pixel regions of different colors are different; and

fabricating a transflective layer on a side, distal from the base substrate, of the transparent insulative layer, wherein the reflective layer, the transparent insulative layer, and the transflective layer in a first pixel region define a first resonant cavity, the first resonant cavity is a resonant cavity corresponding to the first pixel region, and the first pixel region is any one of the plurality of pixel regions.

In some embodiments, the plurality of pixel regions include: a blue pixel region, a green pixel region, and a red pixel region, the transparent insulative layer includes a first transparent insulative block, a second transparent insulative block, and a third transparent insulative block, a material of the first transparent insulative block, a material of the second transparent insulative block, and a material of the third transparent insulative block are the same, the first transparent insulative block is disposed in the blue pixel region, the second transparent insulative block is disposed in the green pixel region, and the third transparent insulative block is disposed in the red pixel region;

fabricating the transparent insulative layer on the side, distal from the base substrate, of the first reflective layer includes:

forming a first transparent insulative sublayer on the side, distal from the base substrate, of the first reflective layer;

etching the first transparent insulative sublayer to remove the first transparent insulative sublayer in the red pixel region and the green pixel region;

forming a second transparent insulative sublayer on a side, distal from the base substrate, of the first transparent insulative sublayer;

etching the second transparent insulative sublayer to remove the second transparent insulative sublayer in the red pixel region; and

forming a third transparent insulative sublayer on a side, distal from the base substrate, of the second transparent insulative sublayer; wherein in the blue pixel region, the first transparent insulative sublayer, the second transparent insulative sublayer, and the third transparent insulative sublayer define the first transparent insulative block, in the green pixel region, the second transparent insulative sublayer and the third transparent insulative sublayer define the second transparent insulative block, and in the red pixel region, the third transparent insulative sublayer defines the third transparent insulative block.

In still another aspect, the embodiments of the present disclosure provide a display panel. The display panel includes a first substrate, a second substrate, and a liquid crystal layer, wherein the first substrate is opposite to the second substrate, and the liquid crystal layer is disposed between the first substrate and the second substrate; and

the first substrate includes:

a base substrate having a plurality of pixel regions; and

a resonant cavity layer, disposed on a first side of the base substrate, wherein the resonant cavity layer includes a plurality of resonant cavities, wherein the plurality of resonant cavities are in one-to-one correspondence with the plurality of pixel regions, the resonant cavity is disposed in the corresponding pixel region, and the resonant cavity is configured to enhance reflection of light of a first color in incident light and reduce reflection of light of a second color in the incident light, wherein the first color is a color corresponding to the pixel region where the resonant cavity is disposed, the second color is a color other than the first color in a color component of the incident light, and the incident light is light incident from one side of the resonant cavity layer.

In some embodiments, the liquid crystal layer is a guest-host liquid crystal layer;

the display panel further includes:

a quarter-wave plate, wherein in a direction perpendicular to the first side, the quarter-wave plate is disposed between the resonant cavity layer and the guest-host liquid crystal layer.

In some embodiments, a thickness of the quarter-wave plate is between 135 nanometers and 140 nanometers.

In some embodiments, the display panel further includes:

a half-wave plate, wherein in the direction perpendicular to the first side, the half-wave plate is disposed between the quarter-wave plate and the resonant cavity layer.

In some embodiments, the display panel further includes:

a half-wave plate, wherein in the direction perpendicular to the first side, the half-wave plate is disposed between the quarter-wave plate and the guest-host liquid crystal layer.

In some embodiments, a thickness of the half-wave plate is between 1 micrometer and 3 micrometers.

In some embodiments, the second substrate includes:

a cover plate;

a color filter layer, disposed on a side, distal from the first side, of the cover plate and corresponding to the plurality of pixel regions;

a black matrix, disposed on the side, distal from the first side, of the cover plate and between adjacent pixel regions; and

a second reflective layer, disposed on a side, distal from the first side, of the black matrix and between adjacent pixel regions.

In some embodiments, the second substrate further includes:

a light-emitting diode, disposed on the side, distal from the first side, of the second reflective layer, wherein the light-emitting diode is disposed between adjacent pixel regions, and an orthographic projection of the light-emitting diode on a surface of the cover plate is within an orthographic projection of the black matrix on the surface of the cover plate.

In still another aspect, the embodiments of the present disclosure provide a display device. The display device includes a power component and the display panel according to any one of the above aspects, wherein the power component is configured to supply power to the display panel.

### BRIEF DESCRIPTION OF THE DRAWINGS

FIG. 1 is a schematic top view of a reflective display substrate according to an embodiment of the present disclosure;

FIG. 2 is a cross-sectional view of an A-A plane in FIG. 1;

FIG. 3 is a flowchart of a method for fabricating a reflective display substrate according to an embodiment of the present disclosure;

FIG. 4 is a fabricating process diagram of a reflective display substrate according to an embodiment of the present disclosure;

FIG. 5 is a flowchart of a method for fabricating a reflective display substrate according to an embodiment of the present disclosure;

FIG. 6 is a fabricating process diagram of a reflective display substrate according to an embodiment of the present disclosure;

FIG. 7 is a flowchart of a fabricating method of a transparent insulative layer according to an embodiment of the present disclosure;

FIG. 8 is a fabricating process diagram of a reflective display substrate according to an embodiment of the present disclosure;

FIG. 9 is a fabricating process diagram of a reflective display substrate according to an embodiment of the present disclosure;

FIG. 10 is a fabricating process diagram of a reflective display substrate according to an embodiment of the present disclosure;

FIG. 11 is a fabricating process diagram of a reflective display substrate according to an embodiment of the present disclosure;

FIG. 12 is a fabricating process diagram of a reflective display substrate according to an embodiment of the present disclosure;

FIG. 13 is a fabricating process diagram of a reflective display substrate according to an embodiment of the present disclosure;

FIG. 14 is a schematic structural diagram of a display panel according to an embodiment of the present disclosure;

FIG. 15 is a schematic diagram of illumination of a display panel according to an embodiment of the present disclosure;

FIG. 16 is a schematic diagram of illumination of a display panel according to an embodiment of the present disclosure;

FIG. 17 is a hierarchical diagram of a display panel according to an embodiment of the present disclosure;

FIG. 18 is a distribution diagram of a light-emitting diode according to an embodiment of the present disclosure; and

FIG. 19 is a graph of wavelength versus reflectivity obtained through an experiment according to an embodiment of the present disclosure.

### DETAILED DESCRIPTION

For clearer descriptions of the objectives, technical solutions, and advantages of the present disclosure, embodiments of the present disclosure are described in detail hereinafter with reference to the accompanying drawings.

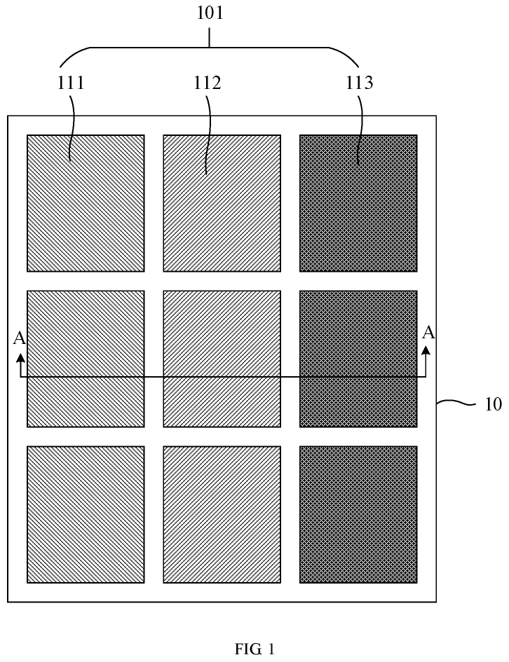

FIG. 1 is a schematic top view of a reflective display substrate according to an embodiment of the present disclosure. Referring to FIG. 1, the reflective display substrate includes a base substrate 10. The base substrate 10 has a plurality of pixel regions 101.

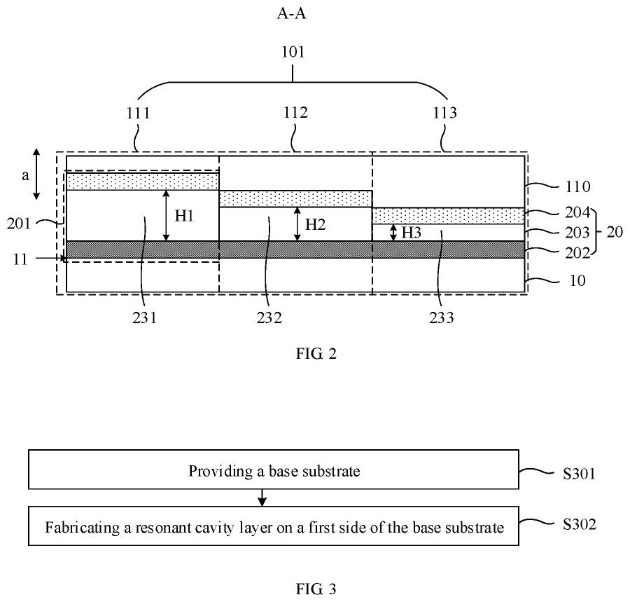

FIG. 2 is a cross-sectional view of an A-A plane in FIG. 1. Referring to FIG. 2, the reflective display substrate includes a resonant cavity layer 20. The resonant cavity layer 20 is disposed on a first side 11 of the base substrate 10. The resonant cavity layer 20 includes a plurality of resonant cavities 201. The plurality of resonant cavities 201 are in one-to-one correspondence with the plurality of pixel regions 101. The resonant cavity 201 is disposed in the corresponding pixel region 101. The resonant cavity 201 is configured to enhance reflection of light of a first color in incident light and reduce reflection of light of a second color in the incident light. The first color is a color corresponding to the pixel region 101 where the resonant cavity 201 is disposed. The second color is a color other than the first color in a color component of the incident light. The incident light is light incident from one side of the resonant cavity layer.

In some embodiments, the incident light is usually natural light or white light provided by a white light source, and color components of the incident light usually include red, green, and blue. For example, in the case that the aforementioned first color is red light, the second color includes green light and blue light.

In the embodiments of the present disclosure, a plurality of resonant cavities are arranged on the base substrate, and the plurality of resonant cavities are in on-to-one correspondence with the plurality of pixel regions. In the case that incident light enters a resonant cavity in the resonant cavity layer, the resonant cavity enhances reflection of light of a first color, and the first color is a color corresponding to the pixel region where the resonant cavity is disposed. Therefore, the reflectivity of the resonant cavity layer is higher than the reflectivity of the reflective layer, such that more light can be emitted from the resonant cavity. Since more light is emitted from the reflective display substrate, the luminance of the reflective display device is improved. At the same time, the resonant cavity can reduce the reflection of light of other colors except the first color in the incident light, such that less light of other colors is emitted from the resonant cavity, and the influence of light of other colors on the display effect is reduced.

In the reflective display substrate, the base substrate 10 is configured to support a structure disposed on the base substrate. In an exemplary embodiment, the base substrate 10 is a glass substrate.

In some embodiments, the base substrate 10 may also be a polyimide (PI) substrate.

In a reflective display panel, a plurality of pixels for luminous display are provided. A region occupied by each pixel is a pixel region. As a part of the reflective display panel, the reflective display substrate may also be divided into a plurality of pixel regions in the same manner. Pixels in the reflective display panel may include blue (B) pixels, green (G) pixels, and red (R) pixels. Accordingly, referring to FIG. 1, the pixel regions 101 includes a blue pixel region 111, a green pixel region 112, and a red pixel region 113.

In the embodiments of the present disclosure, for the blue pixel region 111, the first color is blue, and the second color includes red and green. For the green pixel region 112, the first color is green, and the second color includes red and blue. For the red pixel region 113, the first color is red, and the second color includes blue and green.

In some embodiments, in the blue pixel region 111, in the case that incident light enters the resonant cavity 201 in the blue pixel region 111, the resonant cavity 201 enhances the reflection of blue light and reduces the reflection of red and green light, such that more blue light is emitted from the blue pixel region 111, thereby increasing the display luminance.

Referring again to FIG. 2, the resonant cavity layer 20 includes a first reflective layer 202, a transparent insulative layer 203, and a transflective layer 204. The first reflective layer 202, the transparent insulative layer 203, and the transflective layer 204 are sequentially stacked on the first side 11. The first reflective layer 202, the transparent insulative layer 203, and the transflective layer 204 disposed in a first pixel region define a first resonant cavity. The first resonant cavity is a resonant cavity 201 corresponding to the first pixel region. The first pixel region is any one of the plurality of pixel regions 101.

In some embodiments, the first reflective layer 202, the transparent insulative layer 203, and the transflective layer 204 disposed in the blue pixel region 111 define a resonant cavity 201 corresponding to the blue pixel region 111.

In a direction a perpendicular to the first side 11, thicknesses of the transparent insulative layers 203 in the pixel regions 101 of different colors are different. The incident light has three color components, and the three color components correspond to three wavelengths. Since the thicknesses of the transparent insulative layers 203 in the pixel regions 101 with different colors are different, thicknesses of the resonant cavities 201 of the pixel regions 101 of different colors are different. That is, the lengths of the resonant cavities 201 are different, the time for light of different wavelengths to pass through the resonant cavity 201 is different, and then phase delays caused by light of different wavelengths are different, such that the resonant cavity 201 enhances the reflection of the light of the color corresponding to the pixel region 101 where it is disposed.

The following describes the effect of the resonant cavity 201 in conjunction with the propagation path of the light in the resonant cavity 201 in the blue pixel region 111. In the case that light enters the resonant cavity 201 from the side where the transflective layer 204 is disposed, the light passes through the transparent insulative layer 203 and reaches the first reflective layer 202. The light is reflected by the first reflective layer 202 and enters the transparent insulative layer 203 again. Part of the light is directly transmitted through the transflective layer 204, and part of the light is reflected by the transflective layer 204 back to the resonant cavity 201 again. The light is reflected back and forth between the first reflective layer 202 and the transflective layer 204, such that the mutual interference of the blue light in the resonant cavity 201 is enhanced, and the mutual interference of the red light (or green light) in the resonant cavity 201 is weakened. The blue light enhanced by the mutual interference may eventually be transmitted through the transflective layer 204, while very light green light and red light is transmitted through the transflective layer 204. By controlling the length of the resonant cavity 201, the mutual interference of blue light can be enhanced, and the mutual interference of red light (or green light) can be weakened. Compared with the reflective display substrate in the related art, the reflective display substrate according to the embodiment of the present disclosure increases the amount of blue light emitted from the blue pixel region 111, and improves the display luminance.

Similarly, the resonant cavity 201 disposed in the green pixel region 112 can increase the amount of reflected green light, and the resonant cavity 201 disposed in the red pixel region 113 can increase the amount of reflected red light.

In the embodiments of the present disclosure, the resonant cavity 201 is a Fabry-Perot resonant cavity.

In some embodiments, the resonant cavity 201 may also be other forms of resonant cavities, as long as it is sufficient that interference of the light of the first color is enhanced and interference of the light of the second color is reduced, which is not limited in the present disclosure.

Referring again to FIG. 2, the transparent insulative layer 203 includes a first transparent insulative block 231, a second transparent insulative block 232, and a third transparent insulative block 233. A material of the first transparent insulative block 231, a material of the second transparent insulative block 232, and a material of the third transparent insulative block 233 are the same. The first transparent insulative block 231 is disposed in the blue pixel region 111. The second transparent insulative block 232 is disposed in the green pixel region 112. The third transparent insulative block 233 is disposed in the red pixel region 113. In the direction a perpendicular to the first side 11, a thickness H1 of the first transparent insulative block 231 is greater than a thickness H2 of the second transparent insulative block 232, and the thickness H2 of the second transparent insulative block 232 is greater than a thickness H3 of the third transparent insulative block 233.

The wavelength of blue light is between 460 nanometers and 470 nanometers. The wavelength of green light is between 515 nanometers and 525 nanometers. The wavelength of red light is between 625 nanometers and 635 nanometers. That is, the wavelength of red light is greater than the wavelength of green light, and the wavelength of green light is greater than the wavelength of blue light. By setting the thicknesses of the transparent insulative layers 203 in the pixel regions 101 of the three colors in the above manner, the length of the resonant cavity 201 of the blue pixel region 111 is greater than the length of the resonant cavity 201 of the green pixel region 112, and the length of the resonant cavity 201 of the green pixel region 112 is greater than the length of the resonant cavity 201 of the red pixel region 113, such that the resonant cavity 201 in each pixel region 101 can enhance reflection of light of the corresponding color and improve the luminance of the reflective display device.

In some embodiments, the transparent insulative layer 203 is a silicon dioxide (SiO₂) layer. The transparency of silicon dioxide is good, which can reduce the absorption of light by the transparent insulative layer 203, increase the utilization of light, and further increase the display luminance.

In some embodiments, the transparent insulative layer 203 may also be a silicon nitride layer, a silicon oxynitride layer, or other transparent and insulative material layers.

In the case that a silicon dioxide layer is used as the transparent insulative layer, a thickness of the first transparent insulative block 231 is between 330 nanometers and 350 nanometers; a thickness of the second transparent insulative block 232 is between 295 nanometers and 315 nanometers; and a thickness of the third transparent insulative block 233 is between 190 nanometers and 210 nanometers.

In some embodiments, the first transparent insulative block 231, the second transparent insulative block 232, and the third transparent insulative block 233 are made of the same material. In this case, the first transparent insulative block 231, the second transparent insulative block 232, and the third transparent insulative block 233 have the same density, the same refractive index, but different thicknesses. Phase delays caused by the light in the transparent insulative blocks of different thicknesses are different, such that the three transparent insulative blocks can enhance reflection of light of different wavelengths. In addition, in the case that the transparent insulative layer is made of the same material, there is no need to change the material used for fabrication during the preparation process, and the fabrication process is simpler.

In some embodiments, at least two of the first transparent insulative block 231, the second transparent insulative block 232, and the third transparent insulative block 233 are made of different materials. In this case, the first transparent insulative block 231, the second transparent insulative block 232, and the third transparent insulative block 233 have different densities and different refractive indices. Different speeds at which light propagates in materials with different refractive indices result in different time for the light to pass through the transparent insulative layer 203, that is, phase delays caused the light in the transparent insulative blocks of different refractive indices are different, such that the three transparent insulative blocks can enhance reflection of light of different wavelengths.

In the case that the transparent insulative layer 203 is made of different materials, the thickness of the transparent insulative layer 203 needs to be set accordingly to ensure the reflection enhancement effect for the light of the first color. In other words, by controlling the material and thickness of the transparent insulative layer 203, the resonant cavity 201 in the blue pixel region 111 can enhance the reflection of blue light, the resonant cavity 201 in the green pixel region 112 can enhance the reflection of green light, and the resonant cavity 201 in the red pixel region 113 can enhance the reflection of red light. As a result, the light emitted from each pixel region is increased, and the display luminance is improved.

In the embodiments of the present disclosure, in the case that the materials of the first transparent insulative block 231, the second transparent insulative block 232, and the third transparent insulative block 233 are different, the thicknesses of the first transparent insulative block 231, the second transparent insulative block 232, and the third transparent insulative block 233 may be set to be the same. In this case, during the selection of materials, it is necessary to ensure that the density of the first transparent insulative block 231 is greater than the density of the second transparent insulative block 232, and the density of the second transparent insulative block 232 is greater than the density of the third transparent insulative block 233.

In the embodiments of the present disclosure, the first reflective layer 202 is a silver (Ag) layer, and the higher reflectivity of silver can enable more light to be reflected by the first reflective layer 202, which improves the utilization of light and enhances the display luminance.

In some embodiments, the first reflective layer 202 may be an aluminum (Al) layer, a stack of indium tin oxide (ITO), silver and indium tin oxide, or a stack of silver and titanium (Ti), which is not limited in the present disclosure.

In some embodiments, a thickness of the first reflective layer 202 is between 90 nanometers and 110 nanometers. For example, the thickness of the first reflective layer 202 is 100 nanometers.

In the embodiments of the present disclosure, the transflective layer 204 is a tungsten (W) layer. Tungsten has both reflectivity and certain transmittance, such that light passes through the transflective layer 204 and enters the resonant cavity 201, and is reflected by the transflective layer 204.

In some embodiments, a thickness of the transflective layer 204 is between 5 nanometers and 15 nanometers.

In some embodiments, the transflective layer 204 may be another material layer that has both transmittance and reflectivity, such as a titanium layer.

Referring again to FIG. 2, the reflective display substrate further includes a first planarization layer 110 disposed on a side, distal from the base substrate 10, of the transflective layer 204. Since the resonant cavities have different lengths, the resonant cavity layers 20 in different regions have different thicknesses. After the resonant cavity layer 20 is formed, the surface of the reflective display substrate is uneven. Fabricating the first planarization layer 110 on the transflective layer 204, which makes the surface of the reflective display substrate after the first planarization layer 110 is formed more even, thereby facilitating the fabrication of subsequent film layers.

FIG. 3 is a flowchart of a method for fabricating a reflective display substrate according to an embodiment of the present disclosure. Referring to FIG. 3, the method includes the following steps.

In S301, a base substrate is provided.

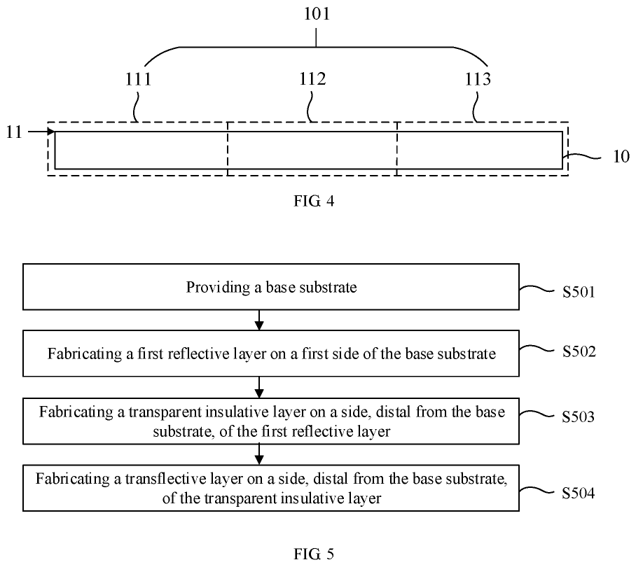

FIG. 4 is a fabricating process diagram of a reflective display substrate according to an embodiment of the present disclosure. Referring to FIG. 4, a base substrate 10 is provided. The base substrate 10 has a plurality of pixel regions 101.

In some embodiments, the base substrate 10 is a glass substrate.

In S302, a resonant cavity layer is fabricated on a first side of the base substrate.

The resonant cavity layer has a plurality of resonant cavities in one-to-one correspondence with the plurality of pixel regions. The resonant cavity is disposed in the corresponding pixel region. The resonant cavity is configured to enhance reflection of light of a first color in incident light and reduce reflection of light of a second color in the incident light. The first color is a color corresponding to the pixel region where the resonant cavity is disposed. The second color is a color other than the first color in a color component of the incident light. The incident light is light incident from one side of the resonant cavity layer.

FIG. 5 is a flowchart of a method for fabricating a reflective display substrate according to an embodiment of the present disclosure. Referring to FIG. 5, the method includes the following steps.

In S501, a base substrate is provided. The base substrate has a plurality of pixel regions.

In some embodiments, a plurality of pixel regions 101 include: a blue pixel region 111, a green pixel region 112, and a red pixel region 113.

In S502, a first reflective layer is fabricated on a first side of the base substrate.

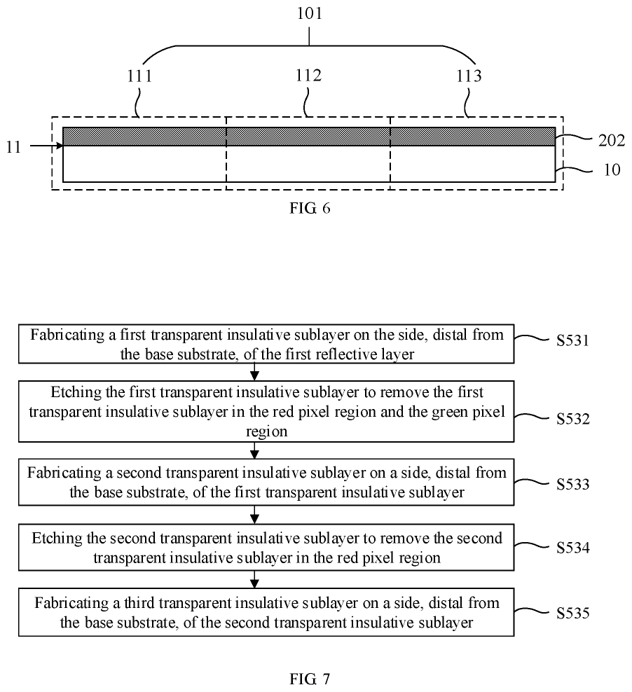

FIG. 6 is a fabricating process diagram of a reflective display substrate according to an embodiment of the present disclosure. Referring to FIG. 6, a first reflective layer 202 is formed on the base substrate 10.

In some embodiments, the first reflective layer 202 may be a silver layer, an aluminum layer, a stack of indium tin oxide, silver and indium tin oxide, or a stack of silver and titanium.

some embodiments, the first reflective layer 202 may be fabricated on the base substrate 10 by a sputtering method.

In S503, a transparent insulative layer is fabricated on a side, distal from the base substrate, of the first reflective layer.

In some embodiments, the transparent insulative layer is a silicon dioxide layer, a silicon nitride layer, or a silicon oxynitride layer.

In a direction perpendicular to the first side, thicknesses of the transparent insulative layers in the pixel regions of different colors are different.

The transparent insulative layer 203 includes a first transparent insulative block, a second transparent insulative block, and a third transparent insulative block. A material of the first transparent insulative block, a material of the second transparent insulative block and a material of the third transparent insulative block are the same. The first transparent insulative block is disposed in the blue pixel region, the second transparent insulative block is disposed in the green pixel region, and the third transparent insulative block is disposed in the red pixel region.

FIG. 7 is a flowchart of a fabricating method of a transparent insulative layer according to an embodiment of the present disclosure. Referring to FIG. 7, S503 includes the following steps.

In S531, a first transparent insulative sublayer is fabricated on the side, distal from the base substrate, of the first reflective layer.

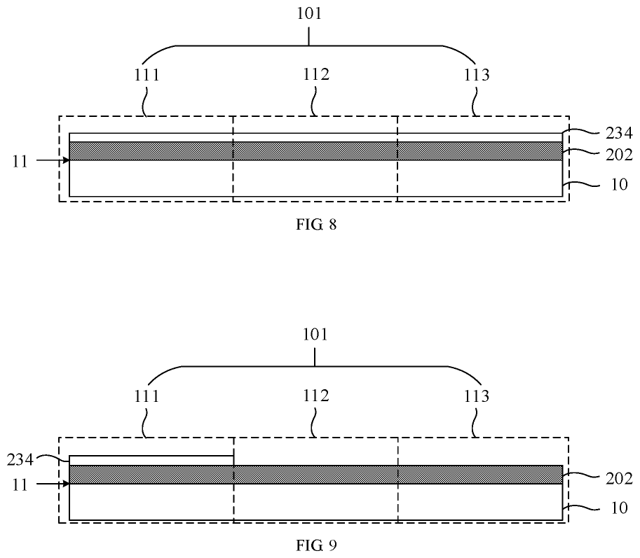

FIGS. 8 to 13 are fabricating process diagrams of a reflective display substrate according to an embodiment of the present disclosure. The fabricating process of the display substrate is described hereinafter with reference to FIGS. 8 to 13.

Referring to FIG. 8, a first transparent insulative sublayer 234 is formed on a side, distal from the base substrate 10, of the first reflective layer 202.

In some embodiments, the first transparent insulative sublayer 234 may be fabricated on the base substrate 10 by a deposition method.

In some embodiments, a thickness of the first transparent insulative sublayer 234 is 35 nanometers.

In S532, the first transparent insulative sublayer is etched to remove the first transparent insulative sublayer in the red pixel region and the green pixel region.

Referring to FIG. 9, the first transparent insulative sublayer 234 in the red pixel region 113 and the green pixel region 112 is removed, and the first transparent insulative sublayer 234 in the blue pixel region 111 is left.

In some embodiments, a layer of photoresist is first coated on the first transparent insulative sublayer 234 in the blue pixel region 111, and then the photoresist is exposed by a mask, such that the photoresist forms a fully exposed region (red pixel region 113 and green pixel region 112) and a non-exposed region (blue pixel region 111), which are then processed by a development process to remove the photoresist in the fully exposed region and leave the photoresist in the non-exposed region, and then the first transparent insulative sublayer 234 in the fully exposed region is etched. After the etching is completed, the photoresist in the non-exposed region is stripped to obtain the pattern shown in FIG. 9.

In S533, a second transparent insulative sublayer is fabricated on a side, distal from the base substrate, of the first transparent insulative sublayer.

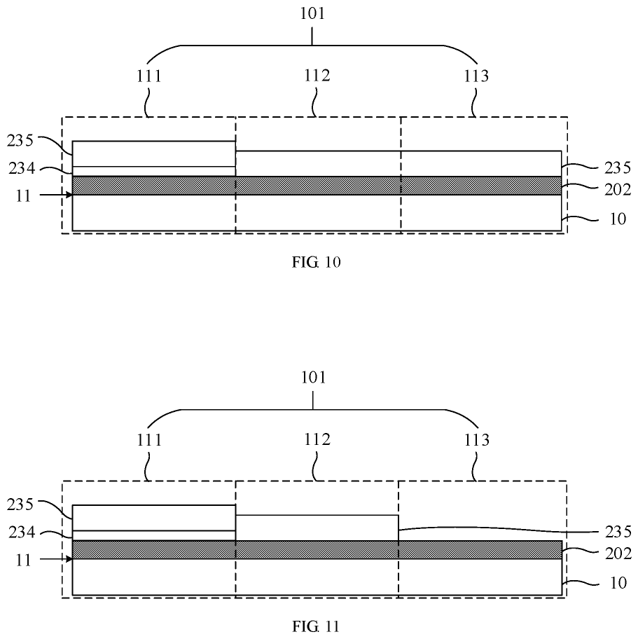

Referring to FIG. 10, a second transparent insulative sublayer 235 is formed on the first transparent insulative sublayer 234.

In some embodiments, the second transparent insulative sublayer 235 may be fabricated on the first transparent insulative sublayer 234 by a deposition method.

In the embodiments of the present disclosure, a thickness of the second transparent insulative sublayer 235 is 105 nanometers.

In S534, the second transparent insulative sublayer is etched to remove the second transparent insulative sublayer in the red pixel region.

Referring to FIG. 11, the second transparent insulative sublayer 235 in the red pixel region 113 is removed, and the second transparent insulative sublayer 235 in the blue pixel region 111 and the green pixel region 112 is left.

In some embodiments, a layer of photoresist is first coated on the second transparent insulative sublayer 235 in the blue pixel region 111 and the green pixel region 112, and then the photoresist is exposed by a mask, such that the photoresist forms a fully exposed region (red pixel region 113) and a non-exposed region (blue pixel region 111 and green pixel region 112), which are then processed by a development process to remove the photoresist in the fully exposed region and leave the photoresist in the non-exposed region, and then the second transparent insulative sublayer 235 in the fully exposed region is etched. After the etching is completed, the photoresist in the non-exposed region is stripped to obtain the pattern shown in FIG. 11.

In S535, a third transparent insulative sublayer is fabricated on a side, distal from the base substrate, of the second transparent insulative sublayer.

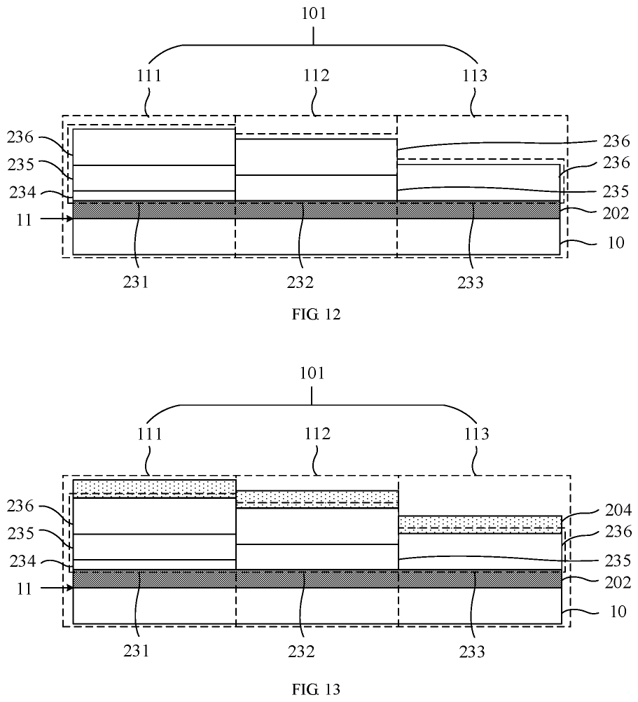

Referring to FIG. 12, a third transparent insulative sublayer 236 is formed on the second transparent insulative sublayer 235.

In the embodiments of the present disclosure, a thickness of the third transparent insulative sublayer 236 is 200 nanometers.

In some embodiments, the third transparent insulative sublayer 236 may be fabricated on the second transparent insulative sublayer 235 by a deposition method.

As shown in FIG. 12, in the blue pixel region 111, the first transparent insulative sublayer 234, the second transparent insulative sublayer 235, and the third transparent insulative sublayer 236 define the first transparent insulative block 231. In the green pixel region 112, the second transparent insulative sublayer 235 and the third transparent insulative sublayer 236 define the second transparent insulative block 232. In the red pixel region 113, the third transparent insulative sublayer 236 defines the third transparent insulative block 233.

In the embodiments of the present disclosure, the transparent insulative layer 203 can be obtained by three depositions and two etchings. Compared with the three depositions and three etchings required to fabricate the transparent insulative layer in different color regions in three times, the steps are reduced, and the fabricating process is simpler. Compared with three etchings, two etchings remove less material, which can save materials.

In S504, a transflective layer is fabricated on a side, distal from the base substrate, of the transparent insulative layer.

Referring to FIG. 13, a transflective layer 204 is formed on the transparent insulative layer 203.

In some embodiments, the transflective layer 204 is a tungsten layer.

In some embodiments, the transflective layer 204 may be fabricated on the transparent insulative layer 203 by sputtering.

As shown in FIG. 13, the first reflective layer 202, the transparent insulative layer 203, and the transflective layer 204 in the blue pixel region 111 define a resonant cavity corresponding to the blue pixel region 111. The first reflective layer 202, the transparent insulative layer 203, and the transflective layer 204 in the green pixel region 112 define a resonant cavity corresponding to the green pixel region 112. The first reflective layer 202, the transparent insulative layer 203, and the transflective layer 204 in the red pixel region 113 define a resonant cavity corresponding to the red pixel region 113.

Then, a first planarization layer 110 is fabricated on the transflective layer 204 to form the reflective display substrate as shown in FIG. 2.

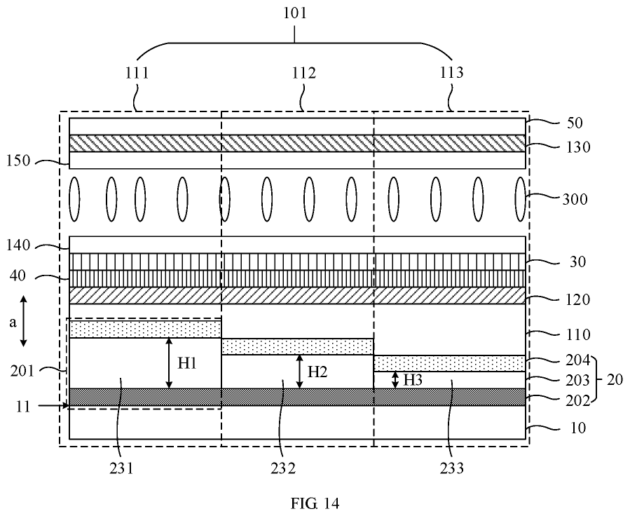

FIG. 14 is a schematic structural diagram of a display panel according to an embodiment of the present disclosure. Referring to FIG. 14, the display panel includes a first substrate 100, a second substrate 200, and a liquid crystal (LC) layer 300. The first substrate 100 is opposite to the second substrate 200. The liquid crystal layer 300 is disposed between the first substrate 100 and the second substrate 200. The first substrate 100 is a reflective display substrate shown in any of the above drawings.

In some embodiments, the first substrate 100 and the second substrate 200 may form a display panel in a box-to-box manner.

In some embodiments, the liquid crystal layer 300 is a guest-host liquid crystal layer, that is, liquid crystal molecules in the liquid crystal layer 300 are guest-host liquid crystal molecules. Guest-host liquid crystal molecules refer to liquid crystal molecules filled with dichroic dye molecules.

Referring again to FIG. 14, the display panel further includes a quarter-wave plate (also referred to as a 214 wave plate) 30. In a direction perpendicular to the first side, the quarter-wave plate 30 is disposed between the resonant cavity layer 20 and the guest-host liquid crystal layer.

In the related art, a reflective display panel includes a color filter substrate and an array substrate that are disposed opposite to each other. A polarizer is disposed on the color filter substrate. A liquid crystal layer is disposed between the color filter substrate and the array substrate. If a bright state is desired, ambient light enters the inside of a liquid crystal cell and is reflected out, and needs to pass through the polarizer twice. The polarizer has a relatively low transmittance, which causes low light utilization and affects display luminance.

In the embodiments of the present disclosure, the guest-host liquid crystals and the quarter-wave plate 30 are adopted to jointly realize the functions of the polarizer and the ordinary liquid crystals. The total transmittance of the guest-host liquid crystals and the quarter-wave plate 30 is greater than the transmittance of the polarizer and the ordinary liquid crystals, such that the light emitted from a display surface is increased and the display luminance is improved.

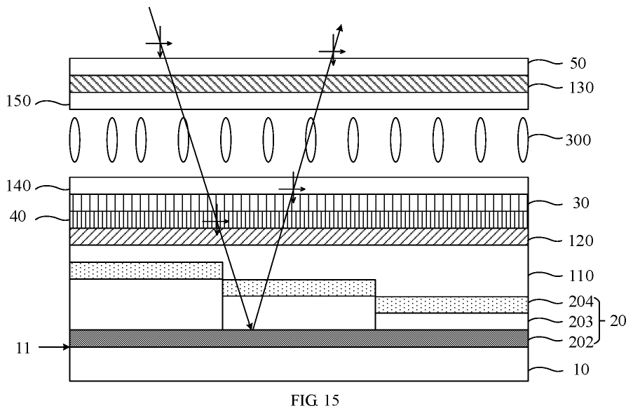

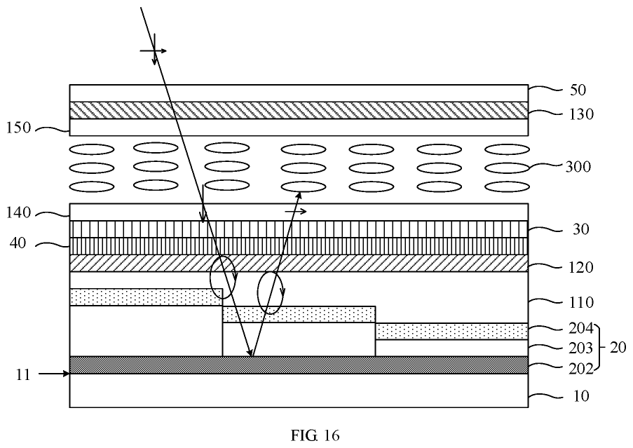

FIGS. 15 and 16 are schematic diagrams of illumination of a display panel according to an embodiment of the present disclosure. The following explains how the display panel according to the embodiment of the present disclosure realizes a dark state and a bright state with reference to FIG. 15 and FIG. 16.

Referring to FIG. 15, in the case that no voltage is applied, an optical axis of the guest-host liquid crystals is perpendicular to the display surface. A polarization state of incident light (ambient light or light from a front light source) may not change during passing through the guest-host liquid crystals. Then the incident light passes through the quarter-wave plate 30, and the polarization state of the light does not change in response to passing through the quarter-wave plate 30. The incident light enters the resonant cavity 201 and is reflected by the resonant cavity 201. The incident light passes through the quarter-wave plate 30 again without changing its polarization state. The incident light passes through the guest-host liquid crystals again and emits from the display surface, thereby causing the display panel to exhibit a bright state.

Referring to FIG. 16, in the case that a voltage is applied, the optical axis of the guest-host liquid crystals is parallel to the display surface. Incident light (ambient light or light from a front light source) passes through the guest-host liquid crystals and becomes first linearly polarized light. A polarization direction of the first linearly polarized light is perpendicular to the direction of the optical axis of the guest-host liquid crystals. The first linearly polarized light passes through the quarter-wave plate 30, and an angle between the optical axis of the quarter-wave plate 30 and the first linearly polarized light is 45 degrees such that the first linearly polarized light become circularly polarized light. The circularly polarized light enters the resonant cavity 201 and is reflected by the resonant cavity 201, and then passes through the quarter-wave plate 30 again. The quarter-wave plate 30 turns the circularly polarized light into second linearly polarized light. A polarization direction of the second linearly polarized light is parallel to the direction of the optical axis of the guest-host liquid crystals and may not pass through the guest-host liquid crystals, thereby causing the display panel to exhibit a dark state.

In the embodiments of the present disclosure, a thickness of the quarter-wave plate 30 is between 135 nanometers and 140 nanometers. For example, the thickness of the quarter-wave plate 30 is 137.5 nanometers.

Referring again to FIGS. 14-16, the display panel further includes a half-wave plate (also referred to as a 212 wave plate) 40. In the direction a perpendicular to the first side, the half-wave plate 40 is disposed between the quarter-wave plate 30 and the resonant cavity layer 20.

The half-wave plate 40 and the quarter-wave plate 30 are superimposed to eliminate dispersion and improve the display effect. At the same time, the polarization direction of the polarized light after passing through the half-wave plate 40 twice is parallel to the original polarization direction, which may not affect the emission of light.

In the embodiment of the present disclosure, a thickness of the half-wave plate 40 is between 1 micrometer and 3 micrometers. For example, the thickness of the half-wave plate 40 is 2 micrometers.

In some embodiments, the half-wave plate 40 may also be disposed between the quarter-wave plate 30 and the guest-host liquid crystal layer.

Referring again to FIGS. 14-16, the first substrate 100 further includes a pixel electrode layer 120. The second substrate 200 includes a common electrode layer 130. The pixel electrode layer 120 is disposed between the first planarization layer 110 and the quarter-wave plate 30. The guest-host liquid crystals are disposed between the pixel electrode layer 120 and the common electrode layer 130. A deflection angle of the guest-host liquid crystals can be adjusted by adjusting a voltage between the pixel electrode layer 120 and the common electrode layer 130, and the amount of light emitted from the guest-host liquid crystals can be controlled to adjust the display luminance of different areas of the display panel.

In the embodiments of the present disclosure, since light needs to pass through the pixel electrode layer 120 and the common electrode layer 130, in order to ensure the transmittance of the pixel electrode layer 120 and the common electrode layer 130, the pixel electrode layer 120 and the common electrode layer 130 are both indium tin oxide layers.

In some embodiments, the pixel electrode layer 120 and the common electrode layer 130 may also be indium zinc oxide (IZO) layers. The materials of the pixel electrode layer 120 and the common electrode layer 130 may be the same or different.

In some embodiments, the quarter-wave plate 30 may be disposed between the first planarization layer 110 and the pixel electrode layer 120.

Referring again to FIGS. 14-16, the first substrate 100 further includes a first alignment film 140. The second substrate 200 further includes a second alignment film 150. The first alignment film 140 and the second alignment film 150 are respectively disposed on both sides of the liquid crystal layer 300.

The first alignment film 140 and the second alignment film 150 can make the arrangement of the liquid crystal molecules in the liquid crystal layer 300 neat. In the case that no voltage is applied, the liquid crystal molecules may be arranged in a predetermined direction to avoid the stray arrangement of liquid crystal molecules, resulting in the scattering of light and the phenomenon of light leakage.

In some embodiments, the first alignment film 140 and the second alignment film 150 may be made of a polyimide material.

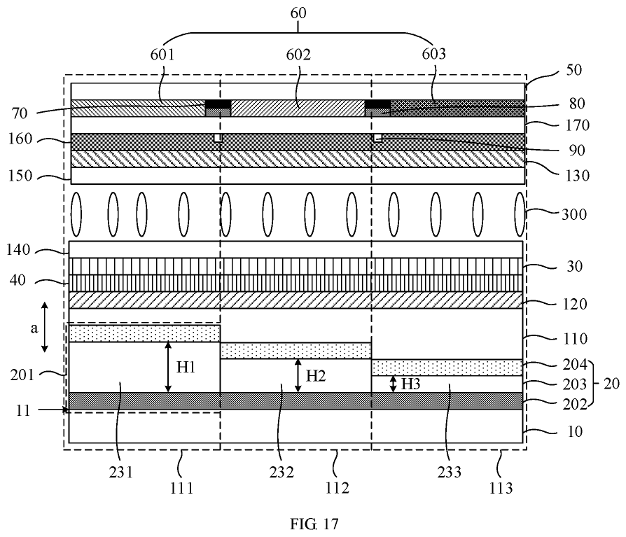

FIG. 17 is a hierarchical diagram of a display panel according to an embodiment of the present disclosure. Referring to FIG. 17, the second substrate 200 further includes a cover plate 50, a color filter layer 60, a black matrix (BM) 70, and a second reflective layer 80. The color filter layer 60 is disposed on a side, distal from the first side, of the cover plate 50 and corresponds to the plurality of pixel regions 101. The black matrix 70 is disposed on the side, distal from the first side, of the cover plate 50 and between adjacent pixel regions 101. The second reflective layer 80 is disposed on a side, distal from the first side, of the black matrix 70 and between adjacent pixel regions 101.

In the embodiments of the present disclosure, the cover plate 50 provides support for the color filter layer 60, the black matrix 70, and the second reflective layer 80. The color filter layer 60 can filter light of a second color to reduce color mixing. The black matrix 70 separates adjacent pixel regions to avoid color mixing between adjacent pixels. At the same time, the black matrix 70 can also block the routing in the display panel to avoid affecting the display effect. However, in the case that the display panel is operating, it is inevitable that light irradiates the black matrix 70, and the black matrix 70 absorbs the light, thereby affecting the utilization of light. The second reflective layer 80 is fabricated on the second substrate 200, and the second reflective layer 80 is opposite to the black matrix 70. The second reflective layer 80 can reflect the light emitted to the black matrix 70 into the display panel, and the light is emitted from the color filter layer 60 upon a plurality of reflections, such that the utilization of light is improved and the display luminance is increased.

In the embodiments of the present disclosure, the cover plate 50 is a glass cover plate to ensure the light transmittance of the cover plate.

As shown in FIG. 17, the color filter layer 60 includes a blue filter layer 601, a green filter layer 602, and a red filter layer 603.

In the embodiments of the present disclosure, the color filter layer 60 can be fabricated by spin coating, exposure, development, and etching. Since the display panel according to the embodiment of the present disclosure is a reflective display panel, the color filter layer 60 is relatively thin to ensure the transmittance of the color filter layer 60, while ensuring that the color filter layer 60 can effectively filter out light of other colors, and a thickness of the color filter layer 60 is between 0.5 μm and 1 μm. The color gamut of the color filter layer 60 is about 30% to ensure the display effect of the display panel.

In the embodiments of the present disclosure, the second reflective layer 80 is a metal layer, and the metal has a higher reflectivity, which can reflect more light into the display panel.

In some embodiments, the second reflective layer 80 is a silver layer.

Referring again to FIG. 17, the second substrate 200 further includes a light-emitting diode (LED) 90. The light-emitting diode 90 is disposed on a side, distal from the display surface of the display panel, of the second reflective layer 80. The light-emitting diode 90 is disposed between adjacent pixel regions 101. A projection of the light-emitting diode 90 on a surface of the cover plate 50 is disposed within a projection of the black matrix 70 on the surface of the cover plate 50.

The light-emitting diode 90 is added to the second substrate 200. In the case that the luminance of the ambient light is low, the light emitted by the light-emitting diode 90 is emitted to the first reflective layer 202 and then emitted from the display panel, so as to improve the display luminance. At the same time, the projection of the light-emitting diode 90 on the surface of the cover plate 50 is disposed within the projection of the black matrix 70 on the surface of the cover plate 50, and the light-emitting diode 90 may not affect the aperture ratio of the display panel.

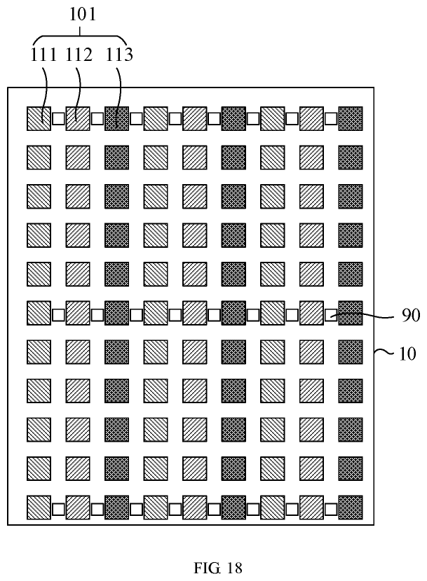

In the embodiments of the present disclosure, there is no need to arrange the light-emitting diodes 90 under the black matrix 70, and the light-emitting diodes 90 under the black matrix 70 may be arranged in a fixed period. FIG. 18 is a distribution diagram of light-emitting diodes according to an embodiment of the present disclosure. Referring to FIG. 18, in every five rows of black matrices 70 (not shown in FIG. 18), the light-emitting diodes 90 are arranged under one row of black matrices 70. That is, in every five rows of pixel regions 101, the light-emitting diodes 90 are arranged in gaps of the pixel regions 101 in one row of pixel regions 101. In other embodiments, the light-emitting diodes 90 may be arranged under one row of black matrices 70 in every ten (or other numerical value) rows of black matrices 70, and the light-emitting diodes 90 may be arranged according to specific conditions, which is not limited in the present disclosure.

In the embodiments of the present disclosure, the black matrix 70 provided with the light-emitting diodes 90 can be appropriately widened to ensure that the black matrix 70 can block the light-emitting diodes 90.

In the embodiments of the present disclosure, the width of the black matrix 70 provided with the light-emitting diodes 90 is between 6 micrometers and 50 micrometers. The width of the black matrix 70 without the light-emitting diodes 90 is between 5 micrometers and 10 micrometers.

In the embodiments of the present disclosure, the light-emitting diode 90 may be a micro LED. The width of the micro LED is a few micrometers. The micro LED can cover the black matrix 70 in the direction perpendicular to the first side to avoid the micro LED affecting the aperture ratio of the display panel. At the same time, a thickness of the micro LED is also a few micrometers, which has little effect on the thickness of the display panel.

As shown in FIG. 17, the display panel further includes an encapsulation layer 160. The encapsulation layer 160 is disposed between the color filter layer 60 and the common electrode layer 130. The light-emitting diode 90 is disposed in the encapsulation layer 160. The encapsulation layer 160 encapsulates the light-emitting diode 90 to facilitate the production of subsequent film layers.

As shown in FIG. 17, the display panel further includes a second planarization layer 170. The second planarization layer 170 is disposed between the color filter layer 60 and the encapsulation layer 160. The second planarization layer 170 can make the surface of the second substrate with the color filter layer 60 fabricated to be flatter to facilitate the production of subsequent film layers.

The structure of the display panel according to the embodiments of the present disclosure can greatly increase the reflectivity of light through experiments, and a maximum reflectivity may reach more than 90%, thereby improving the display luminance.

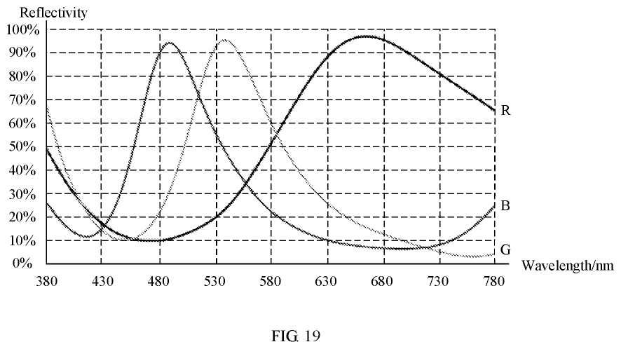

FIG. 19 is a graph of wavelength versus reflectivity obtained through experiments according to an embodiment of the present disclosure. Referring to FIG. 19, the abscissa in the graph is the wavelength of visible light in nanometers; and the ordinate is the reflectivity. The wavelength of visible light is between 380 micrometers and 780 micrometers. The visible light in the ambient light enters the resonant cavities in different pixel regions, and the resonant cavities enhance reflection of light of the corresponding color to enhance the display luminance. Referring to FIG. 19, the display panel according to the embodiment of the present disclosure has different reflectivity to the three colors of ambient light of different wavelengths. For example, the display panel has reflectivity of 10% for red light in ambient light with a wavelength of 480 nanometers, and has reflectivity of 95% for red light in ambient light with a wavelength of 670 nanometers. The reflectivity is higher than the reflectivity of the light of the same wavelength using the reflective layer in the related art. Therefore, the total reflectivity of the display panel to the three-color light according to the embodiments of the present disclosure is increased compared with the related art. That is, it is proved through experiments that the display luminance of the display panel according to the embodiment of the present disclosure is increased. In addition, by using different materials, the thickness of the transparent insulative layer 203 is adjusted such that the sum of the reflectivity for different wavelengths in FIG. 19 is maximized, and a suitable material and thickness of the transparent insulative layer 203 are selected, such as dioxide silicon and corresponding thickness as described above.

An embodiment of the present disclosure also provides a display device. The display device includes a power component and the display panel described in any one of the above embodiments. The power component is configured to supply power to the display panel.

In some embodiments, the display device according to the embodiment of the present disclosure may be any product or component with a display function, such as a mobile phone, a tablet computer, a television, a monitor, a notebook computer, a digital photo frame, and a navigator.

Described above are merely exemplary embodiments of the present disclosure, and are not intended to limit the present disclosure. Within the spirit and principles of the present disclosure, any modifications, equivalent substitutions, improvements, and the like are within the protection scope of the present disclosure.

What is claimed is:

1. A reflective display substrate, comprising:
a base substrate, provided with a plurality of pixel regions; and
a resonant cavity layer, disposed on a first side of the base substrate, wherein
the resonant cavity layer comprises a plurality of resonant cavities, wherein the plurality of resonant cavities are in one-to-one correspondence with the plurality of pixel regions, the resonant cavity is disposed in the corresponding pixel region, and the resonant cavity is configured to enhance reflection of light of a first color in incident light and reduce reflection of light of a second color in the incident light, wherein the first color is a color corresponding to the pixel region where the resonant cavity is disposed, the second color is a color other than the first color in a color component of the incident light, and the incident light is light incident from one side of the resonant cavity layer.

2. The reflective display substrate according to claim 1, wherein the resonant cavity layer comprises a first reflective layer, a transparent insulative layer, and a transflective layer, and wherein the first reflective layer, the transparent insulative layer, and the transflective layer are sequentially stacked on the first side;
the first reflective layer, the transparent insulative layer, and the transflective layer disposed in a first pixel region define a first resonant cavity, wherein the first resonant cavity is a resonant cavity corresponding to the first pixel region, and the first pixel region is any one of the plurality of pixel regions; and
in a direction perpendicular to the first side, thicknesses of the transparent insulative layers in the pixel regions of different colors are different.

3. The reflective display substrate according to claim 2, wherein the plurality of pixel regions comprise a blue pixel region, a green pixel region, and a red pixel region;
the transparent insulative layer comprises a first transparent insulative block, a second transparent insulative block, and a third transparent insulative block, wherein a material of the first transparent insulative block, a material of the second transparent insulative block, and a material of the third transparent insulative block are the same;
the first transparent insulative block is disposed in the blue pixel region, the second transparent insulative block is disposed in the green pixel region, and the third transparent insulative block is disposed in the red pixel region; and
in the direction perpendicular to the first side, a thickness of the first transparent insulative block is greater than a thickness of the second transparent insulative block, and a thickness of the second transparent insulative block is greater than a thickness of the third transparent insulative block.

4. The reflective display substrate according to claim 3, wherein the thickness of the first transparent insulative block is between 330 nanometers and 350 nanometers;
the thickness of the second transparent insulative block is between 295 nanometers and 315 nanometers; and
the thickness of the third transparent insulative block is between 190 nanometers and 210 nanometers.

5. The reflective display substrate according to claim 2, wherein the transparent insulative layer comprises any one of:
a silicon dioxide layer, a silicon nitride layer, and a silicon oxynitride layer.

6. The reflective display substrate according to claim 2, wherein the first reflective layer comprises any one of:
a silver layer, an aluminum layer, an indium tin oxide-silver-indium tin oxide stacked layer, and a silver-titanium stacked layer.

7. The reflective display substrate according to claim 2, wherein the transflective layer comprises any one of:
a tungsten layer and a titanium layer.

8. The reflective display substrate according to claim 1, further comprising a first planarization layer, wherein the first planarization layer is disposed on a side, distal from the base substrate, of the resonant cavity layer.

9. A method for fabricating a reflective display substrate, comprising:
providing a base substrate provided with a plurality of pixel regions; and
fabricating a resonant cavity layer on a first side of the base substrate, wherein
the resonant cavity layer comprises a plurality of resonant cavities, wherein the plurality of resonant cavities are in one-to-one correspondence with the plurality of pixel regions, the resonant cavity is disposed in the corresponding pixel region, and the resonant cavity is configured to enhance reflection of light of a first color in incident light and reduce reflection of light of a second color in the incident light, wherein the first color is a color corresponding to the pixel region where the resonant cavity is disposed, the second color is a color other than the first color in a color component of the incident light, and the incident light is light incident from one side of the resonant cavity layer.

10. The method according to claim 9, wherein fabricating the resonant cavity layer on the base substrate comprises:
fabricating a first reflective layer on the first side of the base substrate;
fabricating a transparent insulative layer on a side, distal from the base substrate, of the first reflective layer, wherein in a direction perpendicular to the first side, thicknesses of the transparent insulative layers in the pixel regions of different colors are different; and
fabricating a transflective layer on a side, distal from the base substrate, of the transparent insulative layer, wherein the reflective layer, the transparent insulative layer, and the transflective layer in a first pixel region define a first resonant cavity, wherein the first resonant cavity is a resonant cavity corresponding to the first pixel region, and the first pixel region is any one of the plurality of pixel regions.

11. The method according to claim 10, wherein the plurality of pixel regions comprise: a blue pixel region, a green pixel region, and a red pixel region, the transparent insulative layer comprises a first transparent insulative block, a second transparent insulative block, and a third transparent insulative block, wherein a material of the first transparent insulative block, a material of the second transparent insulative block, and a material of the third transparent insulative block are the same, the first transparent insulative block is disposed in the blue pixel region, the second transparent insulative block is disposed in the green pixel region, and the third transparent insulative block is disposed in the red pixel region;
fabricating the transparent insulative layer on the side, distal from the base substrate, of the first reflective layer comprises:
forming a first transparent insulative sublayer on the side, distal from the base substrate, of the first reflective layer;
etching the first transparent insulative sublayer to remove the first transparent insulative sublayer in the red pixel region and the green pixel region;
forming a second transparent insulative sublayer on a side, distal from the base substrate, of the first transparent insulative sublayer;
etching the second transparent insulative sublayer to remove the second transparent insulative sublayer in the red pixel region; and
forming a third transparent insulative sublayer on a side, distal from the base substrate, of the second transparent insulative sublayer;
wherein in the blue pixel region, the first transparent insulative sublayer, the second transparent insulative sublayer, and the third transparent insulative sublayer define the first transparent insulative block, in the green pixel region, the second transparent insulative sublayer and the third transparent insulative sublayer define the second transparent insulative block, and in the red pixel region, the third transparent insulative sublayer defines the third transparent insulative block.

12. A display panel, comprising a first substrate, a second substrate, and a liquid crystal layer, wherein the first substrate is opposite to the second substrate, and the liquid crystal layer is disposed between the first substrate and the second substrate; and
the first substrate comprises:
a base substrate having a plurality of pixel regions; and
a resonant cavity layer disposed on a first side of the base substrate, wherein
the resonant cavity layer comprises a plurality of resonant cavities, wherein the plurality of resonant cavities are in one-to-one correspondence with the plurality of pixel regions, the resonant cavity is disposed in the corresponding pixel region, and the resonant cavity is configured to enhance reflection of light of a first color in incident light and reduce reflection of light of a second color in the incident light, wherein the first color is a color corresponding to the pixel region where the resonant cavity is disposed, the second color is a color other than the first color in a color component of the incident light, and the incident light is light incident from one side of the resonant cavity layer.

13. The display panel according to claim 12, wherein the liquid crystal layer is a guest-host liquid crystal layer; and
the display panel further comprises:
a quarter-wave plate, wherein in a direction perpendicular to the first side, the quarter-wave plate is disposed between the resonant cavity layer and the guest-host liquid crystal layer.

14. The display panel according to claim 13, wherein a thickness of the quarter-wave plate is between 135 nanometers and 140 nanometers.

15. The display panel according to claim 13, further comprising:
a half-wave plate, wherein in the direction perpendicular to the first side, the half-wave plate is disposed between the quarter-wave plate and the resonant cavity layer.

16. The display panel according to claim 13, further comprising:
a half-wave plate, wherein in the direction perpendicular to the first side, the half-wave plate is disposed between the quarter-wave plate and the guest-host liquid crystal layer.

17. The display panel according to claim 16, wherein a thickness of the half-wave plate is between 1 micrometer and 3 micrometers.

18. The display panel according to claim 12, wherein the second substrate comprises:
a cover plate;
a color filter layer, disposed on a side, distal from the first side, of the cover plate and corresponding to the plurality of pixel regions;
a black matrix, disposed on the side, distal from the first side, of the cover plate and between adjacent pixel regions; and
a second reflective layer, disposed on a side, distal from the first side, of the black matrix and between adjacent pixel regions.

19. The display panel according to claim 18, wherein the second substrate further comprises:
a light-emitting diode, disposed on the side, distal from the first side, of the second reflective layer, wherein the light-emitting diode is disposed between adjacent pixel regions, and an orthographic projection of the light-emitting diode on a surface of the cover plate is within an orthographic projection of the black matrix in the surface of the cover plate.

20. A display device, comprising a power component and the display panel according to claim 12, wherein the power component is configured to supply power to the display panel.
